(19) United States
(12) Patent Application Publication
(10) Pub. No.: US 2018/0241269 A1
(43) Pub. Date: Aug. 23, 2018

(54) Electric Machine With Stator Windings For Reduced Torque Ripple

(71) Applicant: Ford Global Technologies, LLC, Dearborn, MI (US)

(72) Inventors: Chun Tang, Canton, MI (US); Feng Liang, Troy, MI (US); Wei Wu, Northville, MI (US); Michael W. Degner, Novi, MI (US)

(21) Appl. No.: 15/435,777

(22) Filed: Feb. 17, 2017

(51) Int. Cl. H02K 3/28; B60L 15/02

(52) U.S. Cl. CPC H02K 3/28; H02K 2213/03; B60L 15/025

(57) ABSTRACT

An electric machine includes a stator carrying two sets of multiphase windings. The sets are electrically isolated from each other and have an angular space displacement of A° electric corresponding to a torque ripple of harmonic order N. Responsive to current flow through the sets with a phase shift of A° electric, N±1 harmonic orders of resulting stator magnetic fields cancel to preclude formation of the torque ripple of harmonic order N.

### TECHNICAL FIELD

This disclosure relates to winding configurations for electric machines.

### BACKGROUND

Hybrid electric vehicles (HEVs) and battery electric vehicles (BEVs) may include a traction battery that provides power to a traction motor for propulsion, and a power inverter therebetween to convert direct current (DC) power to alternating current (AC) power. The typical AC traction motor is a 3-phase motor powered by 3 sinusoidal signals each driven with 120 degrees phase separation.

### SUMMARY

An electric machine includes a stator carrying two sets of multiphase windings electrically isolated from each other and having an angular space displacement of A° electric corresponding to a torque ripple of harmonic order N such that, responsive to current flowing through the sets with a phase shift of A° electric, N±1 harmonic orders of resulting stator magnetic fields cancel to preclude formation of the torque ripple of harmonic order N.

An automotive powertrain includes an electric machine that provides propulsive force to wheels. The electric machine includes a stator carrying two sets of multiphase windings electrically isolated from each other and having an angular space displacement of A° electric such that, responsive to current flowing through the sets with a phase shift of A° electric, fundamental orders of resulting stator magnetic fields are in phase and N±1 harmonic orders of the resulting stator magnetic fields cancel to preclude formation of a torque ripple of harmonic order N.

An electric machine includes a stator and a plurality of sets of multiphase windings. The sets are wound on the stator so as to be electrically isolated from each other and have an angular space displacement of A° electric, and configured to generate stator magnetic fields with N±1 harmonic orders that cancel to preclude formation of torque ripple of harmonic order N responsive to current flowing through the sets with a phase shift of A° electric.

### BRIEF DESCRIPTION OF THE DRAWINGS

FIG. 1 is an electric machine winding diagram.

FIG. 2 is a plot of respective currents flowing through the windings of FIG. 1 and phase shifted by A° electric.

FIGS. 3A and 3B are respective vector representations of N−1 and N+1 harmonic orders of magnetic fields resulting from current flow through the windings of FIG. 1.

FIG. 4 is a vector representation of fundamental components of magnetic fields resulting from current flow through the windings of FIG. 1.

FIGS. 5, 6 and 7 are other electric machine winding diagrams.

FIG. 8 is a schematic diagram of a vehicle.

### DETAILED DESCRIPTION

Various embodiments of the present disclosure are described herein. However, the disclosed embodiments are merely examples and other embodiments may take various and alternative forms that are not explicitly illustrated or described. The figures are not necessarily to scale; some features may be exaggerated or minimized to show details of particular components. Therefore, specific structural and functional details disclosed herein are not to be interpreted as limiting, but merely as a representative basis for teaching one of ordinary skill in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. However, various combinations and modifications of the features consistent with the teachings of this disclosure may be desired for particular applications or implementations.

Torque ripple within the context of an electric machine can result in noise and vibration. Conventional electric machines have torque ripple of harmonic order N in which values of N are multiples of 6 (6, 12, 18, etc.). This torque ripple of harmonic order N is caused by N±1 harmonic orders of stator magnetic fields that result from current flow through stator windings. Winding configurations contemplated herein promote cancellation of the N±1 harmonic orders of stator magnetic fields so as to preclude formation of torque ripple of harmonic order N, and in-phase alignment of fundamental components of the stator magnetic fields to increase average torque.

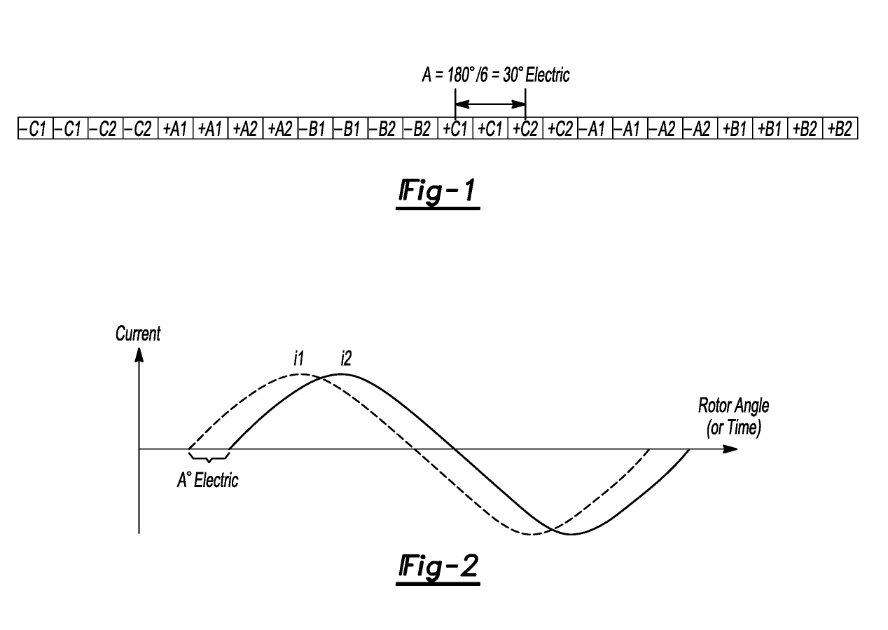

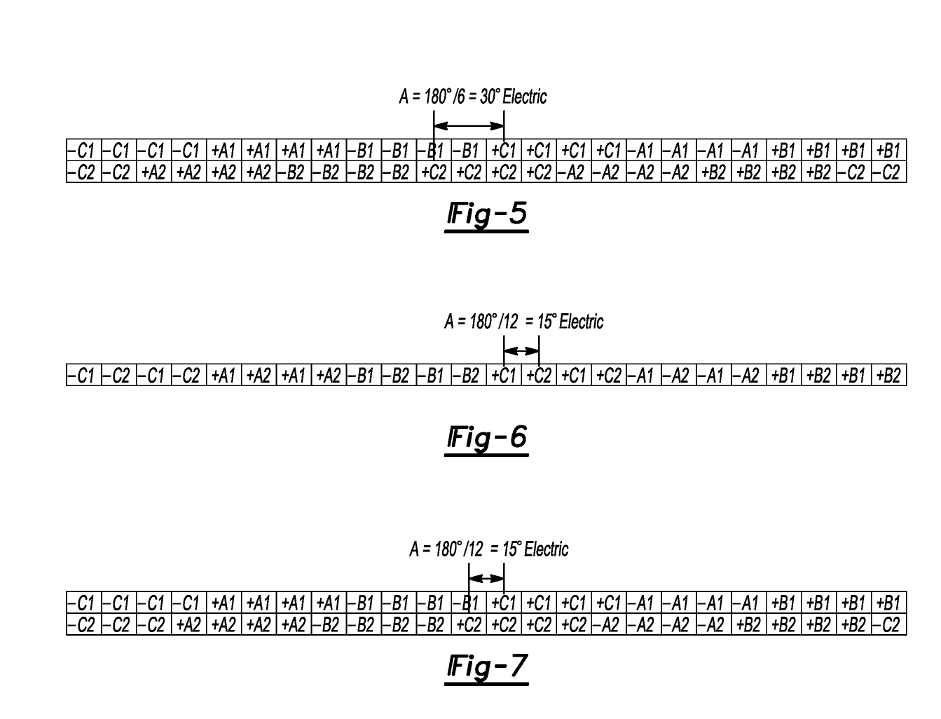

FIG. 1 is an example winding configuration for a single-layer, 48-slot, 4-pole electric machine (permanent magnetic machine, etc.). Two sets of insulated multiphase windings, each having three phases, are wound in a twenty four slot sequence that repeats. The sets of multiphase windings are represented by the numbers “1” and “2.” The phases of each of the sets are represented by the letters “A,” “B,” and “C.” The polarity of the phases is represented by the “+” and “−” symbols. And, the stator carrying the sets is represented by the collection of boxes. This convention is also used in FIGS. 5, 6 and 7.

The angular space displacement, in A° electric, between corresponding phases of the multiphase windings is such that a value of A° electric is equal to the quotient of 180° and N. As explained in further detail below, defining the relationship between the angular space displacement in A° electric and torque ripple of harmonic order N creates circumstances in which, provided that current flowing through the multiphase windings is also phase shifted by A° electric as shown in FIG. 2, the N±1 harmonic orders of resulting stator magnetic fields cancel to preclude formation of torque ripple of harmonic order N. And, fundamental components of the resulting stator magnetic fields are in phase to increase average torque. In the example of FIG. 1, N is equal to 6. That is, N is selected so as to preclude formation of torque ripple of harmonic order 6. As such, the value of A° electric is 30° electric.

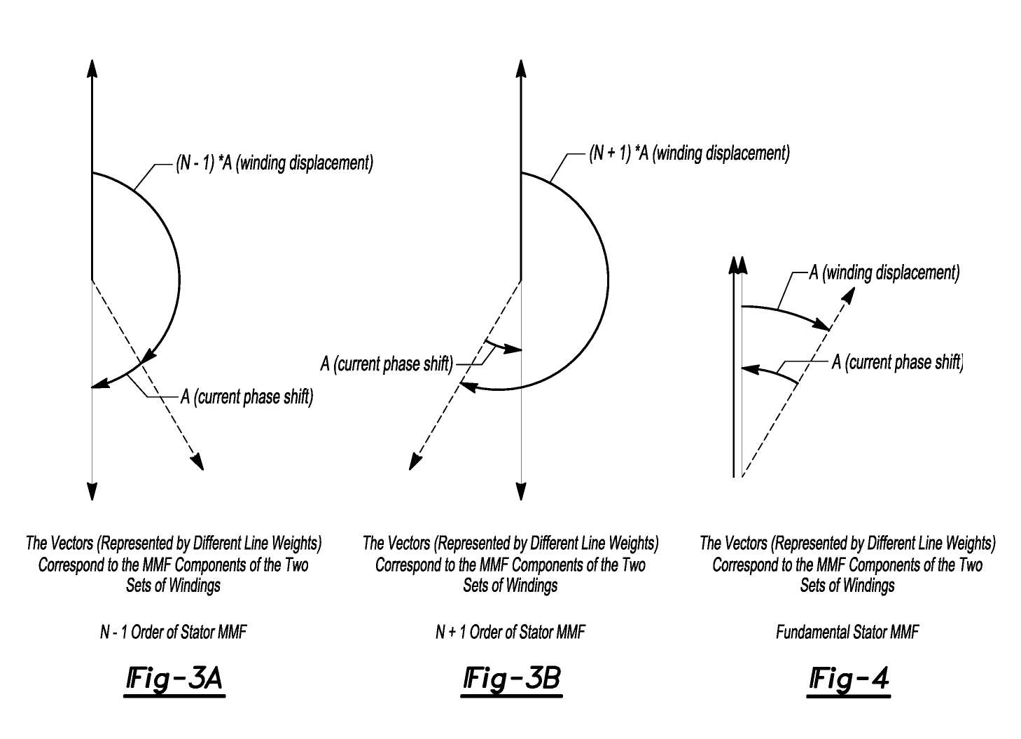

FIGS. 3A and 3B are respective vector representations of the N−1 and N+1 harmonic orders of the resulting stator magnetic fields associated with FIG. 1. FIG. 3A shows that the angle between one of the fields relative to the other is shifted to the location of the dashed line as a result of the angular space displacement according to the relationship (N−1)*A, and the angle is further shifted according to the phase shift between the respective currents flowing through the respective windings such that the angle between the fields is 180°. FIG. 3B likewise shows that the angle between the two fields is shifted to the location of the dashed line according to the relationship (N+1)*A, and the angle is further shifted (but in the opposite direction) according to the phase shift between the respective currents such that the angle between the fields is 180°. As such, the N±1 harmonic orders of the resulting stator magnetic fields cancel. This precludes formation of torque ripple of harmonic order N.

FIG. 4 is a vector representation of the fundamental components of the resulting stator magnetic fields associated with FIG. 1. Although the angular space displacement between the windings acts to shift the angle between one of the fundamental components relative to the other, the phase shift between the respective currents counteracts the shift so that the fundamental components remain in phase. This increases average torque.

FIG. 5 is an example winding configuration for a double-layer, 48-slot, 4-pole electric machine. Two sets of insulated multiphase windings, each having three phases, are wound (such that one of the sets occupies an outer portion of the slots (upper row) and the other of the sets occupies an inner portion of the slots (bottom row)) in a twenty four slot sequence that repeats. In the example of FIG. 5, N is equal to 6. As such, the value of A° electric is 30° electric. That is, the first set of windings is displaced by 30° electric relative to the second set.

FIG. 6 is an example winding configuration for a single-layer, 48-slot, 4-pole electric machine. Two sets of insulated multiphase windings, each having three phases, are wound in a twenty four slot sequence that repeats. In the example of FIG. 6, N is equal to 12. As such, the value of A° electric is 15° electric.

FIG. 7 is an example winding configuration for a double-layer, 48-slot, 4-pole electric machine. Two sets of insulated multiphase windings, each having three phases, are wound (such that one of the sets occupies an outer portion of the slots (upper row) and the other of the sets occupies an inner portion of the slots (bottom row)) in a twenty four slot sequence that repeats. In the example of FIG. 7, N is equal to 12. As such, the value of A° electric is 15° electric. That is, the first set of windings is displaced by 15° electric relative to the second set.

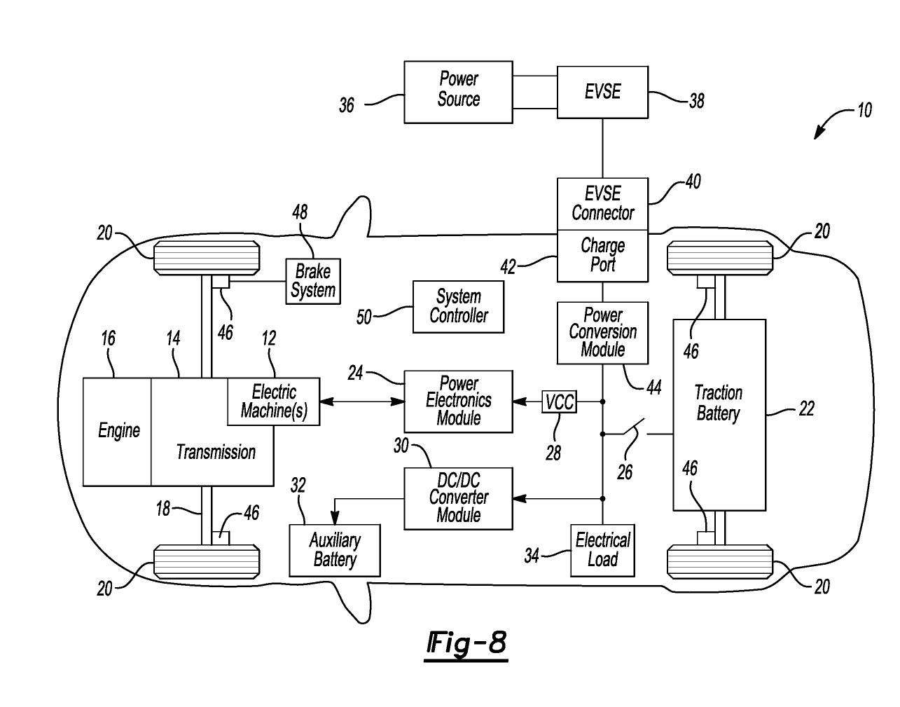

The electric machines and winding configurations contemplated herein may be used in a variety of contexts. One such context is automotive. To this end, FIG. 8 is a schematic diagram of a plug-in hybrid-electric vehicle (PHEV) 10. The vehicle 10 includes one or more electric machines 12 as described above mechanically coupled to a transmission 14. The transmission 14 is mechanically coupled to an engine 16, and a drive shaft 18 that is mechanically coupled to wheels 20.

The electric machines 12 operate as a motor or a generator. They can provide propulsion and deceleration capability when the engine 16 is on or off, and fuel economy benefits by recovering energy that would normally be lost as heat in a friction braking system. The electric machines 12 may also reduce vehicle emissions by allowing the engine 16 to operate at more efficient speeds.

A traction battery or battery pack 22 stores energy that can be used by the electric machines 12. The traction battery 22 provides a high-voltage direct current (DC) output and is selectively electrically coupled to a power electronics module 24. One or more contactors 26 isolate the traction battery 22 from other components when opened, and connect the traction battery 22 to other components when closed. The power electronics module 24 is also electrically coupled to the electric machines 12 and provides the ability to bi-directionally transfer energy between the traction battery 22 and electric machines 12. For example, the traction battery 22 may provide a DC voltage while the electric machines 12 operate with a three-phase alternating current (AC) to function. The power electronics module 24 converts the DC voltage to a three-phase AC current to operate the electric machines 12. In a regenerative mode, the power electronics module 24 converts the three-phase AC current from the electric machines 12 to DC voltage compatible with the traction battery 22.

The vehicle 10 also includes a variable-voltage converter (VVC) 28 electrically between the traction battery 22 and the power electronics module 24. The VVC 28 may be a DC/DC boost converter configured to increase or boost the voltage provided by the traction battery 22. By increasing the voltage, current requirements may be decreased leading to a reduction in wiring size for the power electronics module 24 and the electric machines 12. Further, the electric machines 12 may be operated with better efficiency and lower losses.

In addition to providing energy for propulsion, the traction battery 22 provides energy for other vehicle electrical systems. The vehicle 10 further includes a DC/DC converter module 30 that converts the high-voltage DC output of the traction battery 22 to a low voltage DC supply that is compatible with low-voltage vehicle loads. An output of the DC/DC converter module 30 is electrically coupled to an auxiliary battery 32 (e.g., 12V battery) for charging the auxiliary battery 32. Low-voltage systems may be electrically coupled to the auxiliary battery 32. One or more electrical loads 34 are coupled to the high-voltage bus. The electrical loads 34 may have an associated controller that operates and controls the electrical loads 34 when appropriate. Examples of electrical loads 34 include a fan, an electric heating element, an air-conditioning compressor, etc.

The vehicle 10 is configured to recharge the traction battery 22 from an external power source 36. The external power source 136 may be a connection to an electrical outlet. The external power source 36 is electrically coupled to a charger or electric vehicle supply equipment (EVSE) 38. The external power source 36 may be an electrical power distribution network or grid as provided by an electric utility company. The EVSE 38 provides circuitry and controls to regulate and manage the transfer of energy between the power source 36 and vehicle 10. The external power source 36 provides DC or AC electric power to the EVSE 38. The EVSE 38 has a charge connector 40 for plugging into a charge port 42 of the vehicle 10. The charge port 42 may be any type of port configured to transfer power from the EVSE 38 to the vehicle 10. The charge port 42 is electrically coupled to a charger or on-board power conversion module 44. The power conversion module 44 conditions the power supplied from the EVSE 38 to provide the proper voltage and current levels to the traction battery 22. The power conversion module 44 interfaces with the EVSE 38 to coordinate the delivery of power to the vehicle 10. The EVSE 38 may have pins that mate with corresponding recesses of the charge port 42. Alternatively, various components described as being electrically coupled or connected may transfer power using a wireless inductive coupling.

One or more wheel brakes 46 provide for decelerating the vehicle 10 and preventing motion of the vehicle 10. The wheel brakes 46 may be hydraulically actuated, electrically actuated, or some combination thereof. The wheel brakes 46 are part of a brake system 48. The brake system 48 may include other components to operate the wheel brakes 46. For simplicity, FIG. 8 depicts a single connection between the brake system 48 and one of the wheel brakes 46. A connection between the brake system 48 and the other wheel brakes 46 is implied. The brake system 48 may include a controller to monitor and coordinate the brake system 48. The brake system 48 monitors the brake components and controls the wheel brakes 46 for vehicle deceleration. The brake system 48 responds to driver commands and may also operate autonomously to implement features such as stability control. The controller of the brake system 48 may implement a method of applying a requested brake force when requested by another controller or sub-function.

Electronic modules in the vehicle 10 may communicate via one or more vehicle networks. The vehicle network may include a plurality of channels for communication. One channel of the vehicle network may be a serial bus such as a Controller Area Network (CAN). One of the channels of the vehicle network may include an Ethernet network defined by the Institute of Electrical and Electronics Engineers (IEEE) 802 family of standards. Additional channels of the vehicle network may include discrete connections between modules and may include power signals from the auxiliary battery 32. Different signals may be transferred over different channels of the vehicle network. For example, video signals may be transferred over a high-speed channel (e.g., Ethernet) while control signals may be transferred over CAN or discrete signals. The vehicle network may include any hardware and software components that aid in transferring signals and data between modules. The vehicle network is not shown in FIG. 8 but it may be implied that the vehicle network may connect to any electronic module that is present in the vehicle 10. A vehicle system controller (VSC) 50 may be present to coordinate the operation of the various components.

While example embodiments are described above, it is not intended that these embodiments describe all possible forms encompassed by the claims. A single inverter may be used to drive the sets of windings or respective inverters may be used to drive the respective sets of windings. Four different winding configurations were discussed in detail. Others, however, are also contemplated; for example, a double layer winding configuration corresponding to N=18 and A° electric=10° electric. Moreover, configurations other than 48-slot, 4-pole are of course possible.

The words used in the specification are words of description rather than limitation, and it is understood that various changes may be made without departing from the spirit and scope of the disclosure and claims. As previously described, the features of various embodiments may be combined to form further embodiments that may not be explicitly described or illustrated. While various embodiments may have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electric machine comprising:
a stator carrying two sets of multiphase windings electrically isolated from each other and having an angular space displacement of A° electric corresponding to a torque ripple of harmonic order N such that, responsive to current flowing through the sets with a phase shift of A° electric, N±1 harmonic orders of resulting stator magnetic fields cancel to preclude formation of the torque ripple of harmonic order N.

2. The electric machine of claim 1, wherein fundamental orders of the stator magnetic fields are in phase.

3. The electric machine of claim 1, wherein a value of A° electric is equal to a quotient of 180° and N.

4. The electric machine of claim 1, wherein the sets are arranged in a single layer configuration.

5. The electric machine of claim 1, wherein the sets are arranged in a double layer configuration.

6. The electric machine of claim 1, wherein a value of N is a multiple of 6.

7. An automotive powertrain comprising:
an electric machine configured to provide propulsive force to wheels, and including a stator carrying two sets of multiphase windings electrically isolated from each other and having an angular space displacement of A° electric such that, responsive to current flowing through the sets with a phase shift of A° electric, fundamental orders of resulting stator magnetic fields are in phase and N±1 harmonic orders of the resulting stator magnetic fields cancel to preclude formation of a torque ripple of harmonic order N.

8. The automotive powertrain of claim 7, wherein a value of A° electric is equal to a quotient of 180° and N.

9. The automotive powertrain of claim 7, wherein the sets are arranged in a single layer configuration.

10. The automotive powertrain of claim 7, wherein the sets are arranged in a double layer configuration.

11. The automotive powertrain of claim 7, wherein a value of N is a multiple of 6.

12. The automotive powertrain of claim 7, wherein the electric machine is a 48-slot, 4-pole electric machine.

13. The automotive powertrain of claim 7, wherein each of the multiphase windings is a 3-phase winding.

14. An electric machine comprising:
a stator; and
a plurality of sets of multiphase windings wound on the stator so as to be electrically isolated from each other and have an angular space displacement of A° electric, and configured to generate stator magnetic fields with N±1 harmonic orders that cancel to preclude formation of torque ripple of harmonic order N responsive to current flowing through the sets with a phase shift of A° electric.

15. The electric machine of claim 14, wherein fundamental orders of the stator magnetic fields are in phase.

16. The electric machine of claim 14, wherein a value of A° electric is equal to a quotient of 180° and N.

17. The electric machine of claim 14, wherein the sets are arranged in a single layer configuration.

18. The electric machine of claim 14, wherein the sets are arranged in a double layer configuration.

19. The electric machine of claim 14, wherein a value of N is a multiple of 6.
